(19) United States
(12) Patent Application Publication
(10) Pub. No.: US 2004/0078136 A1
(43) Pub. Date: Apr. 22, 2004

(54) Tailored trajectory generation system and method

(76) Inventors: Bradley D. Cornell, Lake Stevens, WA (US); John A. Brown, Snohomish, WA (US); William M. Fischer, Bellevue, WA (US); David W. Massy-Greene, Seattle, WA (US); Robert W. Mead, Covington, WA (US); Craig J. Roberts, Bellevue, WA (US)

Correspondence Address: HARNESS, DICKEY & PIERCE, P.L.C., P.O. BOX 828, BLOOMFIELD HILLS, MI, 48303, US

(21) Appl. No.: 10/277,336

(22) Filed: Oct. 22, 2002

(51) Int. Cl. G06G 7/76

(52) U.S. Cl. 701/120; 342/36

(57) ABSTRACT

A system for generating tailored trajectories for aircraft operating in an airspace includes a trajectory generation program. In operation, the system receives real-time data from various aircraft operating in the airspace and stores the real-time data in a medium accessible to the trajectory generation program. The trajectory generation program accesses the real-time data and flight characteristics data associated with a corresponding aircraft to generate a trajectory for the corresponding aircraft that is at least partially tailored to the real-time data and the flight characteristics data.

### FIELD OF THE INVENTION

The present invention relates generally to aircraft traffic management systems and more particularly to the generation of trajectories for aircraft operating in an airspace.

### BACKGROUND OF THE INVENTION

Industry experts predict that neither the current air traffic control (ATC) system nor existing airports will be able to meet the future demand for air travel and commerce. One of the major contributors to the lack of overall system capacity are the capacity constraints during aircraft departure and arrival flight phases (i.e., from takeoff to top of climb and from top of descent to the airport).

Lack of capacity in the air traffic system is reducing the potential market for aircraft manufacturers and negatively impacting airline profitability. In addition, the lack of capacity has also led to increasing ATC system congestion and delays, a most certain source of airline passenger inconvenience and frustration at crowded airports during peak times. Moreover, the benefits of operator investment in current Flight Management Systems (FMS) are not being fully realized because the navigational and operational capabilities of current FMS exceed the air traffic management abilities of existing Air Traffic Services (ATS) ground systems.

In view of the foregoing, it will be readily apparent that it would be highly beneficial to provide air traffic management technology that increases air traffic system capacity even as air traffic levels rise. Ideally, such air traffic management technology would reduce air traffic congestion and delays but would not render aviation unaffordable and/or inaccessible for commercial, military, business and/or general aviation operators.

In this regard, trajectory-based air traffic management technologies are being developed to replace the current vector-based approach. Presently, air traffic controllers direct aircraft operating in the local airspace by providing them with headings and altitudes (i.e., vectors). Accordingly, the air traffic controllers are able to build departure and arrival paths for departing and approaching aircraft that will allow the airspace to best accommodate these aircraft.

In a trajectory-based system, however, each aircraft operating in the airspace would be provided with a precise three-dimensional path or trajectory that includes a lateral, vertical, and speed assignments. These trajectories will enable controllers to maximize arrival and departure capacity while reducing pilot and controller workload. Trajectories will be specified by controllers in a manner that will maximize airspace utilization and ensure appropriate air traffic separation. After receiving its trajectory, each aircraft then flies and monitors its own progress to ensure accurate compliance with the assigned trajectory-based clearance.

Studies and simulations have demonstrated the procedural viability and utility of such trajectory-based operations. However, all of the current proposals for trajectory-based operations require the costly retrofitting of expensive equipment on thousands of aircraft. Moreover, there is likely to be a long transitional period during which such costs are being incurred with few benefits being realized. These financial disincentives stand as substantial obstacles to airline participation with any of the existing trajectory-based air traffic proposals, even after considering the substantial long-term benefits that these approaches might provide.

A trajectory-based operational concept will not be practical unless it can be economically implemented in service. Trajectory-based operations are unlikely to be adopted until operators' required startup capital and retrofit costs are drastically reduced.

Other industry proposals that might achieve comparable increases in air traffic capacity to that of trajectory-based operations are also being considered. However, such proposals also depend on additional aircraft equipage and thus suffer from the same financial drawbacks as described above.

Accordingly, a need remains for a system and method that increases air traffic capacity even as air traffic levels rise, and thus allows for reduced air traffic congestion and delays. Ideally, such a system should be financially practical by eliminating, or at least substantially reducing, operator and Air Traffic Control startup capital and retrofit costs.

### SUMMARY OF THE INVENTION

In one preferred form, the present invention provides a system for generating tailored trajectories for aircraft operating in a local airspace. The system includes a trajectory generation program, which operates with existing avionics widely used by aircraft today. In operation, the system receives real-time weather data from one or more of the aircraft operating in the local airspace and stores the real-time data in a medium accessible to the trajectory generation program. The real-time weather data is loaded into a weather database where it is smoothed and then analyzed by the trajectory generation program. Once the weather data is known, the trajectory generation program accesses real-time flight characteristics data associated with a corresponding aircraft to generate a trajectory for the corresponding aircraft that is at least partially tailored to the real-time weather and flight characteristics data. The system integrates and leverages existing airborne resources (e.g., data link capability, flight management computers) and systems rather than requiring new equipment and the significant investment and retrofitting costs associated therewith. Accordingly, the system enables trajectory-based flight management to be implemented in a financially practical manner.

Further areas of applicability of the present invention will become apparent from the detailed description provided hereinafter. It should be understood that the detailed description and specific examples, while indicating at least one preferred embodiment of the invention, are intended for purposes of illustration only and are not intended to limit the scope of the invention.

### BRIEF DESCRIPTION OF THE DRAWING

The present invention will be more fully understood from the detailed description and the accompanying drawing, wherein:

FIG. 1 is a high-level, block diagram of a tailored trajectory generation system according to a preferred embodiment of the present invention.

### DETAILED DESCRIPTION OF THE PREFERRED EMBODIMENTS

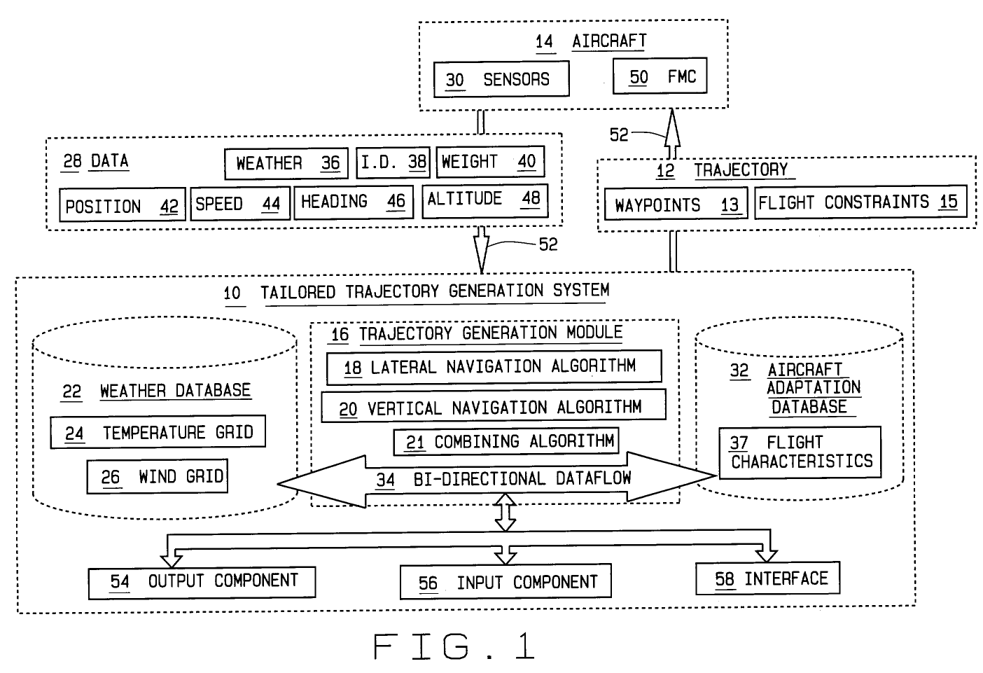

Referring to FIG. 1, there is shown a system 10 for generating tailored trajectories 12 for aircraft 14 operating in a local airspace according to one preferred embodiment of the present invention. Generally, the system 14 includes a trajectory generation program or software module 16 and a real-time weather database 22 that is created and/or updated with real-time data 28 (e.g., weather data 36) transmitted to the system 10 by the various aircraft 14 operating in the local airspace. The system 10 also includes an aircraft adaptation database 32 that contains flight characteristics data 37 for each of the various aircraft types and models that might be operating in the local airspace.

In operation, the system 10 receives the real-time data 28 from the aircraft 14 and stores the real-time data 28 in a medium (e.g., weather database 22) that is accessible to the trajectory generation program 16. The weather database 22 is composed of real-time weather data, which are cross-related and analyzed to create a wind model for the local airspace. The trajectory generation program 16 accesses the databases 22 and 32 via a suitable communications bus 34 to generate a three-dimensional clearance or trajectory 12 for each aircraft 14 operating in the local airspace. The system 10 then sends or transmits the trajectory 12 to the corresponding aircraft 14. In response, each aircraft 14 flies and monitors its own progress on the trajectory 12 to ensure compliance with the waypoints 13 and associated flight constraints 15, such as altitude and/or speed restrictions, along the trajectory path 12. The waypoints 13 and associated altitude and/or speed restrictions 15 may be specified by air traffic control as generated by the trajectory generation program 16. Each aircraft's 14 compliance with the defined trajectory 12 ensures maximum use of airspace capacity and aircraft operating efficiency while reducing pilot and controller workload.

The system 10 integrates and leverages existing resources, data link capability, and flight management computers and systems (e.g., onboard aircraft sensors 30, flight management computers 50, bi-directional data links 52, etc.) rather than requiring new equipment and the significant investment and retrofitting costs associated therewith. Accordingly, the system 10 enables trajectory-based flight management in a financially practical manner, as is later described in greater detail herein.

The real-time weather database 22 of the system 10 will now be discussed in more detail. Because air temperature and wind must be accounted for in trajectory calculations to ensure that the aircraft 14 can accurately conform to the desired trajectory and meet ATC-specified requirements, the weather database 22 preferably includes three-dimensional real-time temperature and wind models 24 and 26 of the local airspace.

To maintain (i.e., create and/or update) the real-time weather database 22, existing sensors 30 on board the various aircraft 14 continuously measure certain weather-related phenomena 36 (e.g., wind speed, wind direction, temperature, among others) transmitted by the aircraft 14 to the system 10. In response to the weather data 36 it is receiving, the system 10 then creates and/or updates, and thus maintains, the highly accurate weather model stored in the weather database 22 for the local airspace. By providing the system 10 with access to real-time weather conditions via the database 22, the system 10 is able to generate more accurate trajectories and to refine the trajectories as required by changing weather conditions, both of which allow for more accurate arrival and departure times.

It should be noted, however, that wind and temperature data from other sources and other weather and/or environmental conditions may also be included within the weather database 22. For example, the weather database 22 may also include information or data pertaining to visibility (e.g., foggy, cloudy, etc.), precipitation (rain, hail, snow, freezing rain, etc.), among others.

At a given airport, it is likely that the various aircraft approaching or departing the airport will include many different aircraft types and models, some or all of which are associated with different flight characteristics. To accommodate for the various aircraft types and models, the system 10 further includes the aircraft adaptation database 32. The aircraft adaptation database 32 contains flight characteristics data 37 for a wide range of aircraft types and models. Accordingly, the system 10 also receives data 38 from each aircraft 14 that allows the system 10 to identify the type of aircraft for which a particular trajectory 12 is being generated and thus to locate within the aircraft adaptation database 32 the particular flight characteristics data 37 associated with the corresponding aircraft 14. By using the flight characteristics data 37, the system 10 is thus able to generate a trajectory 12 that is at least partially tailored or optimized for the aircraft's 14 flight characteristics at the prevailing weight and configuration and in the prevailing environment.

In addition to the weather and aircraft identifying data 36 and 38, the system 10 may also receive the current operating conditions for each aircraft 14. For example, the system 10 may receive data from each aircraft 14 providing the aircraft's weight 40, position 42, speed 44, heading 46, and altitude 48, among other operating conditions.

Regarding the trajectory generation program or software package 16, the trajectory generation program 16 may be embodied in computer-readable program code stored in one or more computer-readable storage media operatively associated with the system 10. Regardless of where it resides, however, the trajectory generation module 16 may comprise program code for accessing the weather and adaptation databases 22 and 32 and for generating the trajectories 12.

It is to be understood, however, that the computer-readable program code described herein can be conventionally programmed using any of a wide range of suitable computer-readable programming languages that are now known in the art or that may be developed in the future. Preferably, however, the computer-readable programming language comprising the trajectory generation module 16 is a cross-plafform compatible computer language.

It is also to be understood that the computer-readable program code described herein can include one or more functions, routines, subfunctions, and subroutines, and may be combined in a single package or embodied in separate components. In addition, the computer-readable program code may be a stand-alone application, or may be a plug-in module for an existing application and/or operating system. Alternatively, the computer-readable program code may be integrated into an application or operating system. In yet another embodiment, the computer-readable program code may reside in one or more network devices (not shown), such as an administrator terminal, a server, etc.

In the preferred embodiment, the trajectory generation module 16 includes a lateral navigation algorithm 18, a vertical navigation algorithm 20, and a combining algorithm 21. In operation, the lateral navigation algorithm 18 generates a lateral clearance portion of the trajectory 12, and the vertical navigation algorithm 20 generates a vertical clearance portion of the trajectory 12. The combining algorithm 21 then uses both the lateral and vertical clearance portions combined with the real-time weather data 24 and 26 and the aircraft database information 37 to produce a single trajectory-based clearance readable by flight management computers. The combining algorithm 21 transforms the lateral and vertical clearance portions into a format encompassing specific waypoint positions and associated flight constraints 15 (e.g., altitude and/or speed constraints) which can be transmitted directly into aircraft Flight Management Systems.

Each trajectory 12 generated by the system 10 is at least partially tailored or customized to the individual aircraft model and its current operating conditions so that each aircraft 14 can comply with its trajectory 12 while using optimized speeds and vertical and horizontal flight paths. Accordingly, each aircraft 14 can thus substantially comply with the trajectory-based clearance issued by ATC with minimal fuel consumption, emission, and noise production. Stated differently, the system 10 calculates dynamic, fuel-efficient and conflict-free departure and arrival paths 12 for the various aircraft 14 operating in the local airspace.

Each trajectory 12 upon generation is in a format that is compatible with the existing flight management computers (FMC) 50 on board the aircraft 14. The system 10 is thus able to uplink or send each trajectory 12 directly to the FMC 50 of the corresponding aircraft 14 via existing ATC data link capabilities and applications such as bi-directional data link 52. Loading the trajectories 12 directly into the FMCs 50 via the data link 52 enables the aircraft 14 to consistently execute complex clearances with a high degree of accuracy, reduces associated pilot and controller workload, and reduces the chance of flight technical/operational errors.

By way of example only, the bi-directional data link 52 through which the aircraft 14 and system 10 communicate may be compatible with the current industry standard ACARS (Aircraft Condition and Reporting System). However, it should be noted that the present invention is not limited to any particular data linking system.

In addition to providing the trajectory 12 to FMCs 50, the system 10 may also include an output component 54 (e.g., graphical display, etc.) suitable for displaying or outputting the trajectories to an air traffic controller. The system 10 will output the trajectories 12 of the approaching and departing aircraft in a unified, easy-to-interpret three-dimensional graphical representation over time.

When a potential conflict exists and/or air traffic has become or is about to become congested, air traffic managers and/or controllers may alleviate the solution through trajectory refinement. That is, air traffic controllers may specify modifications to existing trajectories that will provide air traffic control with additional flexibility to resolve conflicts. To accommodate this feature, the system 10 further includes an interface 58 and an input device 56. In combination, the interface 58 and input and output components 56 and 54 allow for user-interaction with the system 10 and thus user-refinement of trajectories. Whether done manually, automatically, or in a combination thereof, the technique of varying waypoint positions and adding altitude and/or speed constraints at specified waypoints, as required to meet a specific goal, enables an emulated airborne required time of arrival (RTA-like) function to be implemented using ground tools and implemented using existing flight management and data link capabilities.

In another form, the present invention also provides a method for generating tailored trajectories for aircraft operating in an airspace. Generally, the method comprises: receiving real-time data from various aircraft operating in the airspace; accessing flight characteristics data associated with a corresponding aircraft and the real time data; and generating a trajectory for the corresponding aircraft, with the trajectory being at least partially tailored to the flight characteristics data and the real-time data. The method also includes uplinking the trajectory directly to a flight management computer on board the corresponding aircraft. Additionally, the method may also include accessing updated real-time data received from any one of the aircraft operating in the airspace, and then refining the trajectory of the corresponding aircraft, as needed.

The method also includes collecting, distributing, and using real-time weather data to generate and refine trajectories. As described earlier, sensors on board the various arriving and departing aircraft acquire the real-time weather data. While the real-time weather data are being received, the system 10 generates and continuously updates an accurate, localized weather database 22 that includes the three-dimensional real-time temperature and wind grids 24 and 26 representative of the airspace. By using the various aircraft operating within the airspace as wind and temperature sensors and fusing the data acquired thereby with existing weather data and data gathered from other sources, the system 10 is able to provide a high fidelity localized real-time weather model 22. The weather model 22 may then be accessed during the trajectory calculations or refinement because accurate weather data are key components that must be considered to ensure that each aircraft is able to conform to its trajectory and meet ATC-specified requirements.

Accordingly, the present invention provides systems and methods that generate tailored trajectories for aircraft operating in a local airspace in a financially practical and environmentally sensitive manner. In contrast to current proposals for trajectory-based flight management operations which require new equipment, significant investment costs and aircraft retrofitting costs, the present invention instead integrates and exploits the capabilities of existing resources (e.g., data links, flight management computers and systems, etc.) to eliminate, or at least substantially reduce, operator required startup capital and retrofit costs. Although the implementation of the system 10 requires ground system costs, it is anticipated that such costs will be significantly lower than the costs that would be required for implementing any of the other existing trajectory-based flight management proposals. Accordingly, the present invention may be employed as a key sub-component in a local, national, and/or global air traffic management system and thus enable widespread operational participation by a variety of aircraft types without significant operator investment.

Moreover, the present invention also provides at least the following advantages over the current vector-based air traffic management systems:

Increased air traffic capacity;

Improved aircraft and airport operating efficiency;

Reduced pilot workload;

Reduced number of air traffic controller instructions to aircraft, thus reducing air traffic controller workload;

Increased capability to handle additional aircraft due to reduced air traffic controller workload;

Reduced and/or redirected noise and other emissions allowing air traffic to be increased with less environmental impact;

Increased safety through greater predictability, accuracy, and error reduction in day-to-day operations; and

Reduced voice channel congestion.

For each of the above reasons, the present invention is expected to be highly beneficial to the Federal Aviation Administration (FAA), passenger and cargo aircraft operators, airports, pilots, controllers, general aviation users, business jet operators and the military. Some of the benefits and advantages provided by the present invention will now be discussed in greater detail.

At busy airports with frequent takeoffs and landings, the precise trajectory information provided by the present invention will result in a better flow of air traffic and allow for increased air traffic capacity. By providing a more precise view of where aircraft are, and each aircraft's intended trajectory within the airspace, the present invention should significantly raise awareness of the many system participants in the air traffic environment. Safety factors are also enhanced due to the level of precision to which aircraft can adhere to of the flight paths generated by the present invention. Implementation of the present invention will also allow for tighter separation standards to be used, which in turn will significantly and safely increase capacity in the air traffic system.

In addition, the present invention provides more accurate forecasts of traffic volume and real-time flight planning tools that allow for fast-forward simulation of system flows to evaluate potential consequences of flight plans and changes thereto. As is known, flight plans can quickly become outdated as weather or air traffic control actions force schedule and routing changes. With the present invention, however, dynamic replanning capabilities are significantly advanced and more rapid responses may be made to situational changes, thereby greatly reducing delays and cancellations. The system 10 also provides alternative routes for air traffic control to pass to aircraft in the event of conflicts, such as severe weather. Once the suggested routes are approved, each aircraft can fly along its updated trajectory in lieu of its previously determined trajectory.

The real-time features (e.g., real-time detection, response and consequence management) supported by the present invention enhance flight safety. Another beneficial real-time feature of the present invention is the graphical representation of the aircraft paths 12 in three dimensions over time. This feature allows controllers to more readily identify and anticipate potential conflicts and thus take appropriate strategic action in response thereto. For example, air traffic controllers and managers may use such accurate aircraft monitoring to take action that alleviates congestion around crowded airports at peak times. In contrast, current systems are more akin to tactical reaction than strategic action as air traffic controllers must track aircraft as moving dots on a flat display while mentally creating a three-dimensional mental picture of the complex, changing airspace projected in time.

In vector-based air traffic systems, air traffic controllers must provide each aircraft with numerous instructions such as appropriate heading, speed, and altitude. The present invention, however, uses ATC data links to pass the complex trajectories and thus eliminates several voice transmissions that would otherwise be required for each aircraft. Accordingly, the present invention reduces possible flight crew transcription errors and drastically decreases voice frequency congestion, which has been identified as a contributor to both air traffic capacity reduction and safety related issues.

The trajectory-based approach also allows for reductions in aircraft emissions and fuel burn as compared to that of conventional vectored-approach systems. The present invention may also be used to reduce or redirect aircraft noise, thereby allowing for increased flexibility in managing the environmental impacts of departing and arriving aircraft. At many airports, the authority to increase the number of operations is withheld because of noise-related environmental impact. With the present invention, however, the trajectory-based clearances allow the aircraft to fly a precise path with maximum efficiency.

The present invention can also be used to provide relatively immediate notification of potentially hazardous weather phenomena such as clear air turbulence. For example, a pilot encountering clear air turbulence reports the incident to the system, and the system then notifies and warns other pilots in the area. Accordingly, another layer of safety is added to flying because flight crews can use up-to-the-minute information to deal with unseen and potentially dangerous conditions.

It is anticipated that the invention will be applicable to any of a wide range of aircraft (e.g., but not limited to, fighter jets, commercial jets, private jets, propeller powered aircraft, among others) regardless of the manner in which the aircraft is piloted (e.g., directly, remotely, via automation, or in a combination thereof, among others). Accordingly, the specific references to aircraft herein should not be construed as limiting the scope of the present invention to only one specific form/type of aircraft.

The description of the invention is merely exemplary in nature and is in no way intended to limit the invention, its application, or uses. Thus, variations that do not depart from the substance of the invention are intended to be within the scope of the invention. Such variations are not to be regarded as a departure from the spirit and scope of the invention.

What is claimed is:

1. A system for generating tailored trajectories in an airspace, the system comprising a trajectory generation program, the trajectory generation program accessing real-time data provided by aircraft operating in the airspace and accessing flight characteristics data associated with a corresponding aircraft, to generate a trajectory for the corresponding aircraft, the trajectory being at least partially tailored by use of the flight characteristics data and the real-time data.

2. The system of claim 1, wherein the trajectory generation program comprises:
a lateral navigation algorithm for generating a lateral clearance portion of the trajectory;
a vertical navigation algorithm for generating a vertical clearance portion of the trajectory; and
a combining algorithm for producing a trajectory-based clearance readable by flight management computers by using the lateral and vertical clearance portions and the real-time data and flight characteristics data.

3. The system of claim 1, wherein the real-time data comprises real-time weather data acquired by at least one sensor on board at least one aircraft operating within the airspace.

4. The system of claim 3, further comprising a real-time weather database accessible to the trajectory generation program, and including the real-time weather data.

5. The system of claim 4, wherein the real-time weather database comprises:
a three-dimensional real-time wind model of the airspace; and
a three-dimensional real-time temperature model of the airspace.

6. The system of claim 1, wherein:
the system further comprises an aircraft adaptation database accessible to the trajectory generation program, the aircraft adaptation database storing flight characteristics data for a plurality of aircraft types; and
the system uses data provided by the corresponding aircraft to access the corresponding aircraft's flight characteristics data stored within the aircraft adaptation database.

7. The system of claim 1, further comprising a plurality of existing resources, the system using the resources to communicate with the corresponding aircraft.

8. The system of claim 7, wherein the resources comprise:
at least one bi-directional data link between the system and the corresponding aircraft; and
a flight management computer on board the corresponding aircraft.

9. The system of claim 1, further comprises an output component for outputting the trajectory to an air traffic controller.

10. The system of claim 1, further comprising an interface for allowing an air traffic controller to refine the trajectory.

11. The system of claim 1, wherein the trajectory comprises:
a plurality of waypoints; and
a plurality of flight constraints associated, the plurality of waypoints and flight constraints emulating an airborne required time of arrival function for the corresponding aircraft.

12. The system of claim 11, wherein at least one waypoint is generated by the trajectory generation program.

13. The system of claim 12, wherein at least one waypoint is specified by air traffic control.

14. Apparatus for generating tailored trajectories in an airspace, the apparatus comprising:
means for receiving real-time data from aircraft operating in the airspace;
means for accessing flight characteristics data associated with a corresponding aircraft and the real-time data; and
means for generating a trajectory for the corresponding aircraft, the trajectory being at least partially tailored to the flight characteristics data and the real-time data.

15. Apparatus for generating tailored trajectories in an airspace, the apparatus comprising:
a module for receiving real-time data from aircraft operating in the airspace;
a module for accessing flight characteristics data associated with a corresponding aircraft and the real time data; and
a module for generating a trajectory for the corresponding aircraft, the trajectory being at least partially tailored to the flight characteristics data and the real-time data.

16. A method for generating tailored trajectories in an airspace, the method comprising:
receiving real-time data from aircraft operating in the airspace;
accessing flight characteristics data associated with a corresponding aircraft and the real time data; and
generating a trajectory for the corresponding aircraft, the trajectory being at least partially tailored to the flight characteristics data and the real-time data.

17. The method of claim 16, further comprising:
accessing updated real-time data; and
refining the trajectory after accessing updated real-time data.

18. The method of claim 16, wherein:
the real-time data comprises real-time weather data; and
the method further comprises:
maintaining a real-time weather database with the real-time weather data; and
accessing the real-time weather database to acquire the real-time weather data.

19. The method of claim 18, wherein maintaining a real-time weather database with the real-time weather data comprises:
maintaining a three-dimensional real-time wind model of the airspace; and
maintaining a three-dimensional real-time temperature model of the airspace.

20. The method of claim 16, further comprising uplinking the trajectory to a flight management computer on board the corresponding aircraft.

21. The method of claim 16, further comprising acquiring at least a portion of the real-time data with a sensor on board at least one aircraft operating in the airspace.

22. The method of claim 16, further comprising:
receiving identifying data from the corresponding aircraft; and
using the identifying data to locate the flight characteristics data associated with the corresponding aircraft.

23. The method of claim 16, further comprising outputting the trajectory to an air traffic controller.

24. The method of claim 16, further comprising implementing an interface for allowing an air traffic controller to refine the trajectory.

25. The method of claim 16, wherein generating a trajectory comprises:
generating a plurality of waypoints; and
fitting the trajectory to meet a required time of arrival as determined by air traffic control for at least one corresponding waypoint.
